(19) United States
(12) Patent Application Publication
(10) Pub. No.: US 2023/0361267 A1
(43) Pub. Date: Nov. 9, 2023

(54) Method for Manufacturing Positive Electrode Active Material Particles and Secondary Battery

(71) Applicant: Semiconductor Energy Laboratory Co., Ltd., Kanagawa-ken (JP)

(72) Inventors: Yohei Momma, Isehara (JP); Mayumi MIKAMI, Atsugi (JP); Aya UCHIDA, Oyama (JP); Kazuhito MACHIKAWA, Hiratsuka (JP)

(73) Assignee: Semiconductor Energy Laboratory Co., Ltd., Kanagawa-ken (JP)

(21) Appl. No.: 18/221,776

(22) Filed: Jul. 13, 2023

Related U.S. Application Data
(62) Division of application No. 16/609,621, filed on Oct. 30, 2019.

(30) Foreign Application Priority Data
May 3, 2017 (JP) 2017-092039

(51) Int. Cl. H01M 4/04; H01M 4/485; H01M 4/505; H01M 4/525; H01M 4/583; H01M 10/0525

(52) U.S. Cl. CPC H01M 4/0471; H01M 4/0419; H01M 4/485; H01M 4/505; H01M 4/525; H01M 4/5835; H01M 10/0525; H01M 2004/027

(57) ABSTRACT

To provide a positive electrode active material with which the cycle performance of a secondary battery can be improved and a manufacturing method thereof. When a secondary battery is fabricated using, for a positive electrode, a positive electrode active material obtained by depositing a solid electrolyte on a lithium compound with the use of a graphene compound by spray-drying treatment and volatilizing carbon from the graphene compound by heat treatment, the decomposition of an electrolyte solution in contact with the positive electrode active material can be inhibited, contributing to improvement in the cycle performance of the secondary battery.

This application is a divisional of copending U.S. application Ser. No. 16/609,621, filed on Oct. 30, 2019 which is a 371 of international application PCT/IB2018/052700 filed on Apr. 19, 2018 which are all incorporated herein by reference.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, embodiments of the present invention relate to a positive electrode active material that can be used in a secondary battery, a secondary battery, and an electronic device including a secondary battery.

In this specification, a power storage device is a collective term describing elements and devices having a power storage function. Examples thereof include a storage battery (also referred to as secondary battery) such as a lithium-ion secondary battery, a lithium-ion capacitor, and an electric double layer capacitor.

### BACKGROUND ART

A demand for lithium-ion secondary batteries with high output and high capacity has rapidly grown with the development of the semiconductor industry, for portable information terminals such as mobile phones, smartphones, and laptop computers; portable music players; digital cameras; medical equipment; next-generation clean energy vehicles such as hybrid electric vehicles (HEV), electric vehicles (EV), and plug-in hybrid electric vehicles (PHEV); and the like, and the lithium-ion secondary batteries are essential as rechargeable energy supply sources for today's information society.

Lithium-ion secondary batteries are required to have high capacity and high energy density and to be small and lightweight.

In particular, lithium-cobalt composite oxides (LiCoO₂), which allow a voltage as high as 4 V, are widely available as positive electrode active materials of secondary batteries. Patent Document 1 discloses plate-like particles of a positive electrode active material.

### PRIOR ART DOCUMENT

### Patent Document

[Patent Document 1] No. WO 2010/074303

### SUMMARY OF THE INVENTION

### Problems to be Solved by the Invention

If the charging voltage that is applied to a secondary battery can be increased, the secondary battery can be charged at a high voltage for a longer time, resulting in an increase in the amount of charge per unit time and a reduction in charging time. In the field of electrochemical cells typified by lithium-ion secondary batteries, batteries deteriorate when the voltage becomes a high voltage exceeding 4.5 V.

When the charging voltage that is applied to a secondary battery is increased, a side reaction might occur, contributing to a significant decrease in battery performance. A side reaction refers to formation of a reaction product caused by a chemical reaction of an active material or an electrolyte solution. Another side reaction refers to promotion of oxidation and decomposition of an electrolyte solution, and the like. The decomposition of an electrolyte solution might cause gas generation and volume expansion.

An object of one embodiment of the present invention is to inhibit a side effect with an electrolyte solution to improve resistance to high voltages and rate characteristics.

Another object of one embodiment of the present invention is to provide a positive electrode active material which inhibits a reduction in capacity through charge and discharge cycles when used in a lithium-ion secondary battery. Another object of one embodiment of the present invention is to provide a high-capacity secondary battery. Another object of one embodiment of the present invention is to provide a secondary battery with excellent charge and discharge characteristics. Another object of one embodiment of the present invention is to provide a highly safe or highly reliable secondary battery.

Another object of one embodiment of the present invention is to provide a novel material, active material particles, a secondary battery, or a manufacturing method thereof.

Note that the descriptions of these objects do not disturb the existence of other objects. One embodiment of the present invention does not need to achieve all the objects. Other objects can be derived from the descriptions of the specification, the drawings, and the claims.

### Means for Solving the Problems

Ideally, it is preferable to perform modification treatment on positive electrode active material particles so that a side reaction does not occur even when charge and discharge are performed in the state where the modified positive electrode active material particles are in contact with an electrolyte solution. The positive electrode active material particles are each small and the number thereof is large; thus, each of them is desirably modified.

Deterioration of a secondary battery is caused by a chemical reaction such as a side reaction. To inhibit deterioration, an unintended chemical reaction by repeated charge and discharge is prevented so that the state of a positive electrode, an electrolyte solution, or a negative electrode is maintained.

In order to prevent a side reaction in charge and discharge, it is desirable that a protective layer be provided between an electrolyte solution and positive electrode active material particles and the protective layer allow the passage of carrier ions such as lithium ions therethrough. In order not to inhibit movement of carrier ions such as lithium ions, the protective layer is made thin or is provided on only part of the surfaces of the positive electrode active material particles. The protective layer is not necessary in the case where the particles can be modified so as not to easily react with the electrolyte solution.

When mixing is simply performed to modify each of positive electrode active material particles or provide a protective layer thereon, positive electrode active material particles remain unmodified or protective layers provided on positive electrode active material particles vary, and positive electrode active material particles with protective layers and positive electrode active materials without a protective layer coexist. When charge and discharge are performed in such a coexistent state, unmodified positive electrode active material particles and positive electrode active material particles without a protective layer preferentially receive and release carrier ions such as lithium ions, accelerating deterioration of the particles compared with the other particles; as a result, the lifetime of a secondary battery is decreased.

The present inventors have found that to modify each positive electrode active material particle or provide a protective layer thereon, a graphene compound is used and a suspension containing lithium compound particles that contain lithium, a transition metal element, and oxygen, a graphene compound, a solid electrolyte, and a solvent is sprayed from a nozzle of a spray-drying apparatus, whereby the positive electrode active material particles contained in a drop ejected from the nozzle that are in the state of being covered with the graphene compound can be dried. A suspension is a liquid in which solid particles are dispersed, and in the suspension sprayed from a nozzle, there are discrete solid particles, aggregations of two or more solid particles, particles only with a liquid, particles of a mixture of a liquid and solid particles, and the like. Note that solid particles precipitate in a suspension and have a concentration gradient in some cases.

The structure relating to a manufacturing method disclosed in this specification is a method for manufacturing positive electrode active material particles by spraying a suspension containing lithium compound particles that contain lithium, a transition metal element, and oxygen, a graphene compound, a solid electrolyte, and a solvent and performing heating to transform carbon contained in a surface into carbon dioxide and volatilize the carbon.

In the above structure, a spray nozzle with a diameter larger than the size of lithium compound particles is used. A spray nozzle with a diameter larger than that of particles contained in the suspension.

In the above structure, a NASICON phosphate compound is used as the solid electrolyte. The solvent is water and ethanol. The heating is performed at a temperature higher than or equal to the melting point of the solid electrolyte in an air atmosphere. The solid electrolyte refers to a one that has an ionic conductivity and is solid at room temperature, for example, at higher than or equal to 15° C. and lower than or equal to 25° C. The solid electrolyte may be either crystalline or amorphous. The definition of the solid electrolyte may include a gelled polymer solid electrolyte containing a solution. In the above structure, the transition metal is cobalt. In the above structure, a solid phase method is used for fabrication of the lithium compound particles. Note that a method used for fabrication of the lithium compound particles is not limited to a solid phase method, and a sol-gel method may be used.

A secondary battery using positive electrode active material particles obtained by the above manufacturing method is also an invention disclosed in this specification, and the structure of the secondary battery includes a positive electrode including lithium compound particles containing lithium, a transition metal element, and oxygen and a phosphate compound in contact with the lithium compound particles, an electrolyte solution in contact with the lithium compound particles and the phosphate compound, and a negative electrode.

Another structure of the secondary battery includes a positive electrode including lithium compound particles containing lithium, a transition metal element, and oxygen and protective layers in contact with the lithium compound particles, an electrolyte solution in contact with the protective layers, and a negative electrode, and the protective layers contain carbon.

For the protective layers, a solid electrolyte material through which carrier ions such as lithium ions can pass, or the like is used. That is, a plurality of limited materials, specifically, solid electrolyte particles, positive electrode active material particles, and a graphene compound are contained in a drop and the drop is sprayed from a spray nozzle, whereby the state where the positive electrode active material particles and the solid electrolyte particles are attached to each other can be obtained efficiently.

When powder obtained by a spray-drying apparatus is heated at higher than or equal to 800° C., most part of the graphene compound can be transformed into carbon dioxide so that the positive electrode active material particles and the solid electrolyte particles are strongly bonded and the element distribution in the positive electrode active material particle has a gradient, a crystal structure that can resist repeated occlusion and release of lithium ions can be obtained.

Specifically, the lithium compound particles contain magnesium and fluorine and have a gradient such that the concentration of the magnesium or the fluorine is higher in the surfaces of the lithium compound particles than in the inside of the lithium compound particles. After heating, titanium contained in the solid electrolyte particles is dispersed to be contained in the positive electrode active material particles. After heating, the graphene compound may be left and the surfaces of the positive electrode active material particles may have protective layers containing carbon. The carbon can be detected by XRD analysis, Raman spectroscopy, or the like.

A solid electrolyte that can be used for the protective layers is preferably a phosphate compound. A phosphate compound can be more easily dealt with than a sulfide compound and does not generate a harmful gas such as a sulfidizing gas in a manufacturing process. Furthermore, a phosphate compound has an advantage of being stable even in an air atmosphere, precluding the necessity of a large scale of atmosphere control or the like. A phosphate compound containing lithium, aluminum, and titanium (hereinafter referred to as LATP) is a high water-resistant material, called a ceramic electrolyte, and is a glass ceramic electrolyte. The general formula of LATP is Li_{1+X}Al_{X}Ti_{2-X}(PO₄)₃. LATP is a solid electrolyte material having a NASICON crystal structure.

LATP is chemically stable and less likely to become rid of oxygen even when charge and discharge are repeated, and thus oxidation or the like of an electrolyte solution can be prevented.

The protective layers are not limited to one kind of material and two or more kinds of protective layers may be in contact with a surface; for example, the surface of a positive electrode active material particle may have both a layer containing a phosphate compound in a part thereof and a thin layer containing carbon in another part thereof.

### Effect of the Invention

The positive electrode active material particles obtained according to the present invention have a surface that is less likely to react with an electrolyte solution even when charge and discharge are repeated, which can inhibit a reduction in capacity through the charge and discharge cycles. A secondary battery using the positive electrode active material particles obtained according to the present invention can have high capacity. A secondary battery using the positive electrode active material particles obtained according to the present invention exhibits excellent charge and discharge characteristics. A secondary battery using the positive electrode active material particles obtained according to the present invention is highly safe or highly reliable.

### BRIEF DESCRIPTION OF THE DRAWINGS

FIG. 1 is a chart showing a manufacturing flow showing one embodiment of the present invention.

FIG. 2 is a SEM photograph of a positive electrode active material particle before heating that shows one embodiment of the present invention.

FIGS. 3A and 3B are a SEM photograph and a cross-sectional photograph of a positive electrode active material particle after heating that shows one embodiment of the present invention.

FIG. 4 is a diagram illustrating a spray-drying apparatus.

FIGS. 5A-5C are diagrams illustrating a coin-type secondary battery.

FIG. 6 is a graph showing cycle performances.

FIG. 7 is a graph showing cycle performances.

FIGS. 8A-8C are diagrams illustrating a method for charging a secondary battery.

FIGS. 9A-9D are diagrams illustrating a method for charging a secondary battery.

FIG. 10 is a diagram illustrating a method for discharging a secondary battery.

FIGS. 11A-11C are diagrams illustrating application examples.

FIGS. 12A and 12B are diagrams illustrating application examples.

### MODE FOR CARRYING OUT THE INVENTION

Hereinafter, embodiments of the present invention will be described in detail with reference to drawings. Note that the present invention is not limited to the description below, and it is easily understood by those skilled in the art that modes and details of the present invention can be modified in various ways. In addition, the present invention should not be construed as being limited to the description in the embodiments given below.

### Embodiment 1

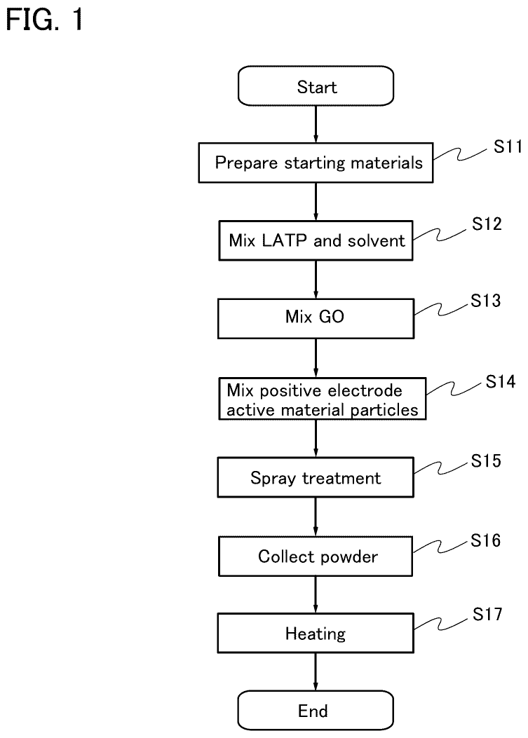

FIG. 1 shows a process flow chart.

First, starting materials are prepared (S11). In this embodiment, an example will be described in which lithium cobalt oxide (LCO) and graphene oxide (also referred to as GO) as positive electrode active materials and LATP (Li_{1.3}Al_{0.3}Ti_{1.7}(PO₄)₃) as a solid electrolyte are weighed and used. After synthesizing LATP by a solid phase method, ball-mill grinding and drying were performed to adjust the particle diameter to an appropriate diameter, whereby LATP particles were obtained. The composition of the LATP particles can be determined from the results of X-ray diffraction analysis (XRD). According to the measurement of particle size distribution, the diameter of the LATP particles is approximately greater than or equal to 100 nm and less than or equal to 5 μm, and the average diameter is 700 nm.

Water and ethanol are put in a container containing LATP particles, and mixing and stirring are performed (S12). The ratio of ethanol to pure water is 4:6. For the stirring, a stirrer is used, the rotation rate is 750 rpm, and irradiation with ultrasonic waves is performed for one minute. Although pure water and ethanol are used as a dispersion medium in (S12), a dispersion medium is not particularly limited thereto, and ethanol may be used alone or an organic solvent such as acetone or 2-propanol may be used.

Next, graphene oxide is put in the container, and mixing and stirring are performed (S13). For the stirring, a stirrer is used, the rotation rate is 750 rpm, and irradiation with ultrasonic waves is performed for one minute. The use of graphene oxide, not a thickener or the like, allows a mixed solution to be formed without isolation and precipitation of LATP.

Then, positive electrode active material particles are put in the container, and mixing and stirring are performed (S14). For the stirring, a stirrer is used, the rotation rate is 750 rpm, and irradiation with ultrasonic waves is performed for one minute. Lithium cobalt oxide particles (product name: C-20F) produced by Nippon Chemical Industrial CO., LTD. are used as positive electrode active material particles, and a suspension is completed. The above lithium cobalt oxide particles produced by Nippon Chemical Industrial CO., LTD. (product name: C-20F) contain at least fluorine, magnesium, calcium, sodium, silicon, sulfur, and phosphorus, and have a diameter of approximately 20 μm.

Then, the suspension is subjected to spray treatment using a spray-drying apparatus (S15).

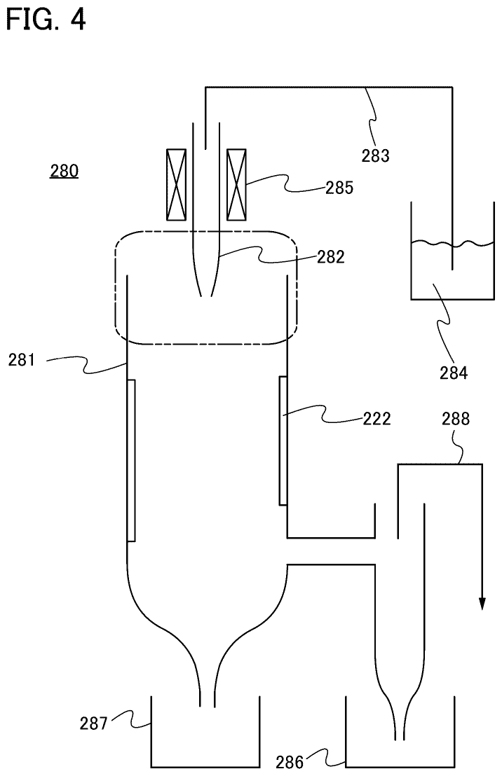

FIG. 4 shows a schematic view of a spray-drying apparatus 280. The spray-drying apparatus 280 includes a chamber 281 and a nozzle 282. A suspension 284 is supplied to the nozzle 282 through a tube 283. The suspension 284 is supplied in the form of mist from the nozzle 282 to the chamber 281 and dried in the chamber 281. The nozzle 282 may be heated with a heater 285. Here, a region of the chamber 281 which is close to the nozzle 282, for example, a region surrounded by dashed-two dotted line in FIG. 4, is also heated with the heater 285.

In the case of using a suspension containing a positive electrode active material, LATP, and graphene oxide as the suspension 284, powder of the positive electrode active material to which LATP and graphene oxide are attached is collected in collection containers 286 and 287 through the chamber 281.

The air in the chamber 281 may be suctioned by an aspirator or the like through a path indicated by an arrow 288.

The suspension was sprayed uniformly with a spray nozzle (having a nozzle diameter of 20 μm) of the spray-drying apparatus to obtain powder. The inlet temperature was 160° C. and the outlet temperature was 40° C. as the hot-air temperature of the spray-drying apparatus, and the nitrogen gas flow rate was 10 L/min. Although a nitrogen gas was used here, an argon gas may be used.

Then, the powder is collected in the collection container 287 (S16).

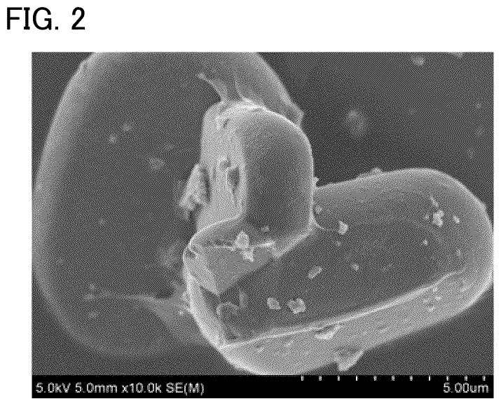

FIG. 2 shows a SEM photograph of the powder obtained in the collection container 287. In FIG. 2, a portion where small LATP particles are deposited on a positive electrode active material particle and graphene oxide is deposited thereon can be observed. Composed of a plurality of materials, the particle shown in FIG. 2 can also be referred to as a composite structure body.

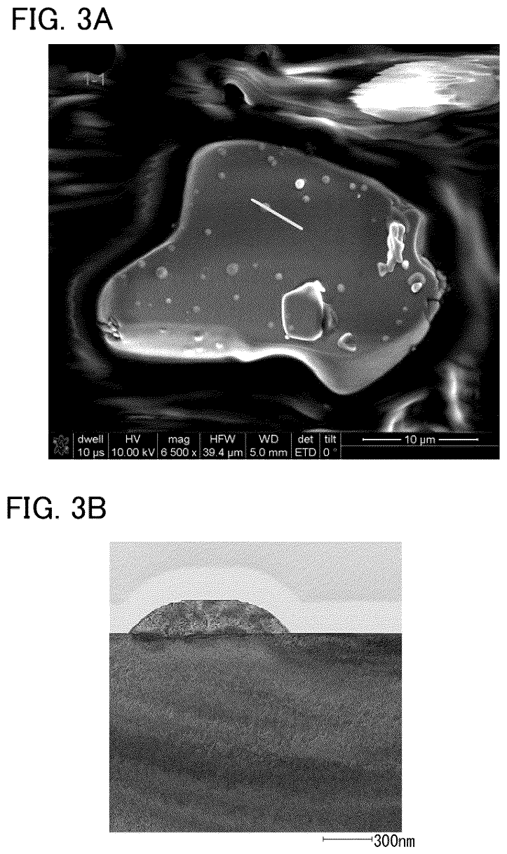

The powder obtained in the collection container 287 was subjected to heat treatment in an air atmosphere at a heating temperature higher than or equal to the temperature for LATP synthesis, here at 900° C., for two hours (S17). Note that the temperature increase temperature is 200° C./hour. FIG. 3(A) shows a SEM photograph of the powder after the heat treatment. In the photograph of the powder after the heat treatment, the state where graphene oxide was attached that was seen before the heating was not observed, which suggests that a major part became carbon dioxide.

FIG. 3(B) shows a cross-sectional view taken along the straight line in FIG. 3(A).

A change in the composition by heat treatment was checked by XPS analysis. Table 1 shows the results.

TABLE 1

| Conditions for samples | Li | Co | O | Mg | F | Ti | C | P | Al | Ca | Na | S | Zr |
|---|---|---|---|---|---|---|---|---|---|---|---|---|---|
| Without heat treatment | 6.7 | 15.0 | 55.0 | 0.5 | 2.2 | 0.9 | 14.6 | 3.2 | 0.0 | 1.2 | 0.0 | 0.7 | 0.0 |
| With heat treatment | 12.6 | 12.5 | 47.3 | 7.3 | 6.5 | 1.7 | 6.0 | 0.6 | 0.0 | 1.1 | 1.9 | 2.4 | 0.0 |

quantitative value (atomic %)

Note that measurement was performed on positive electrode active material particles using the same amounts of materials (0.5 wt % graphene oxide and 2 wt % LATP) with or without heating at 900° C. after spraying. The results in Table 1 show a feature that the particle subjected to heating contained higher amounts of lithium, magnesium, fluorine, and titanium than the particle not subjected to heating.

Presumably, heat treatment caused a solid diffusion reaction, magnesium and fluorine were diffused from the inside of the positive electrode active material particle to the vicinity of the surface, the grain boundary, and a defect portion such as a crack portion, and thus, the concentrations of magnesium and fluorine in the vicinity of the surface were increased. In addition, it is supposed that LATP particles smaller than a lithium cobalt oxide particle were attached to the lithium cobalt oxide particle, and titanium was diffused from LATP and detected in the vicinity of the surface. It can also be said that in this manner, the surface of the positive electrode active material particle was modified and a new layer was formed on the surface of the positive electrode active material particle. A positive electrode of a secondary battery that is formed using positive electrode active material particles each with the new layer functioning as a protective layer has a surface that is less likely react with an electrolyte solution even when subjected to repeated charge and discharge, contributing to inhibition of a decrease in the capacity through the charge and discharge cycles. Although an example in which layered rock-salt lithium cobalt oxide is used as positive electrode active material particles is described in this embodiment, there is no particular limitation, and materials for a high charging voltage (4.5 V or higher), specifically, lithium nickel-manganese-cobalt oxide, lithium nickel oxide, and lithium nickel-cobalt-aluminum oxide, each of which is of a layered rock-salt type, lithium nickel-manganese oxide (LiNi_{0.5}Mn_{1.5}O₄), which is of a spinel type, and the like can be used.

In order to form the new layer, the amount of LATP particles is preferably controlled to be a very small amount greater than 0.2 wt % and less than 8 wt %, preferably greater than or equal to 1 wt % and less than or equal to 3 wt %.

In order to mix materials and perform spray treatment, the concentration of graphene oxide is preferably greater than or equal to 0.2 wt %, or less than or equal to 0.6 wt % in consideration of cost of graphene oxide.

### Embodiment 2

In this embodiment, examples will be described in which vehicles each include the secondary battery of one embodiment of the present invention.

The use of secondary batteries in vehicles enables production of next-generation clean energy vehicles such as hybrid electric vehicles (HEVs), electric vehicles (EVs), and plug-in hybrid electric vehicles (PHEVs).

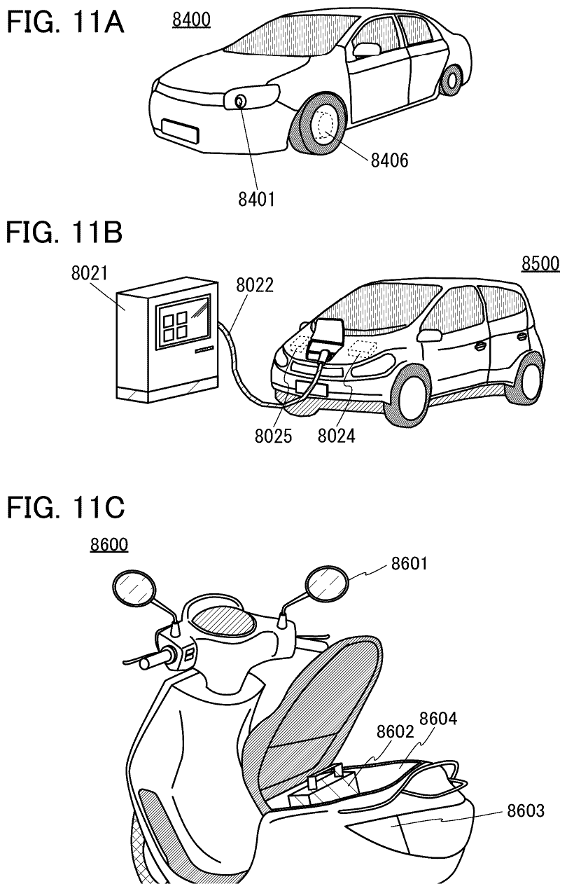

FIG. 11 illustrates examples of vehicles each using the secondary battery of one embodiment of the present invention. An automobile 8400 illustrated in FIG. 11(A) is an electric vehicle that runs on an electric motor as a power source. Alternatively, the automobile 8400 is a hybrid electric vehicle capable of driving using either an electric motor or an engine as a power source, as appropriate. The use of the secondary battery of one embodiment of the present invention allows fabrication of a high-mileage vehicle. The automobile 8400 includes the secondary battery. As the secondary battery, the modules of laminated secondary batteries may be arranged to be used in a floor portion in the automobile. Alternatively, a battery pack in which a plurality of secondary batteries are combined may be placed in the floor portion in the automobile. The secondary battery is capable of suppling electric power to a light-emitting device such as a headlight 8401 or a room light (not illustrated) as well as driving an electric motor 8406.

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 11(B) can be charged when the secondary battery included in the automobile 8500 is supplied with electric power through external charging equipment by a plug-in system, a contactless power feeding system, or the like. FIG. 11(B) illustrates the state in which the secondary battery 8024 included in the automobile 8500 is charged with a ground-based charging apparatus 8021 through a cable 8022. In charging, a given method such as CHAdeMO (registered trademark) or Combined Charging System may be employed as a charging method, the standard of a connector, or the like as appropriate. The ground-based charging apparatus 8021 may be a charging station provided in a commerce facility or a power source in a house. For example, with the use of a plug-in technique, the secondary battery 8024 included in the automobile 8500 can be charged by being supplied with electric power from outside. The charge can be performed by converting AC electric power into DC electric power through a converter such as an ACDC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 11(C) is an example of a motorcycle using the secondary battery of one embodiment of the present invention. A motor scooter 8600 illustrated in FIG. 11(C) includes a secondary battery 8602, side mirrors 8601, and indicators 8603. The secondary battery 8602 can supply electric power to the indicators 8603.

Furthermore, in the motor scooter 8600 illustrated in FIG. 11(C), the secondary battery 8602 can be held in a storage unit under seat 8604. The secondary battery 8602 can be held in the storage unit under seat 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle characteristics and the capacity of the secondary battery can be increased. Thus, the secondary battery itself can be made more compact and lightweight. Making the secondary battery itself more compact and lightweight contributes to a reduction in the weight of a vehicle, and thus increases the mileage. Furthermore, the secondary battery included in the vehicle can be used as a power source for supplying electric power to things other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle characteristics can be used over a long period; thus, the use amount of rare metals such as cobalt can be reduced.

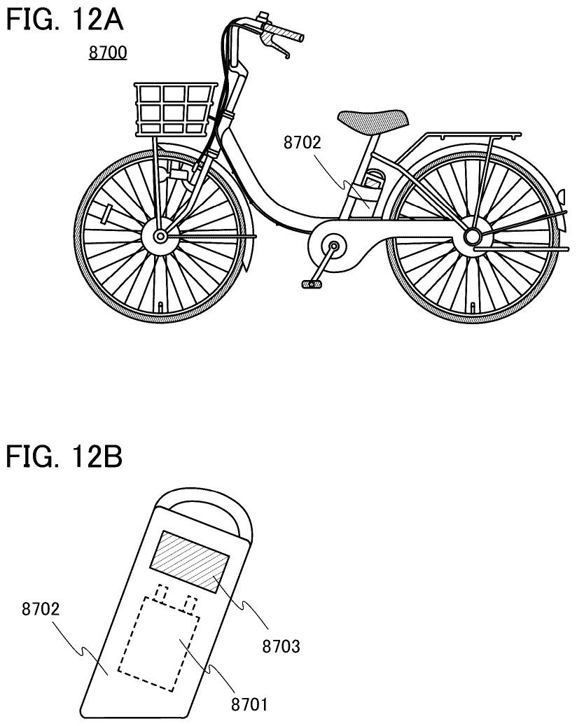

FIG. 12(A) is an example of an electric bicycle using a plurality of secondary batteries of one embodiment of the present invention in a battery pack. The electric bicycle 8700 illustrated in FIG. 12(A) is provided with a battery pack 8702. The battery pack 8702 can supply electric power to a motor that assists a rider. The battery pack 8702 is portable, and FIG. 12(B) illustrates the state where the battery pack 8702 is detached from the bicycle. The battery pack 8702 incorporates a plurality of laminated secondary batteries 8701 and can display the remaining battery level and the like on a display portion 8703. In the case of incorporating a plurality of secondary batteries, the battery pack 8702 includes a charge control circuit and a protection circuit.

This embodiment can be implemented in appropriate combination with the other embodiments.

### Example 1

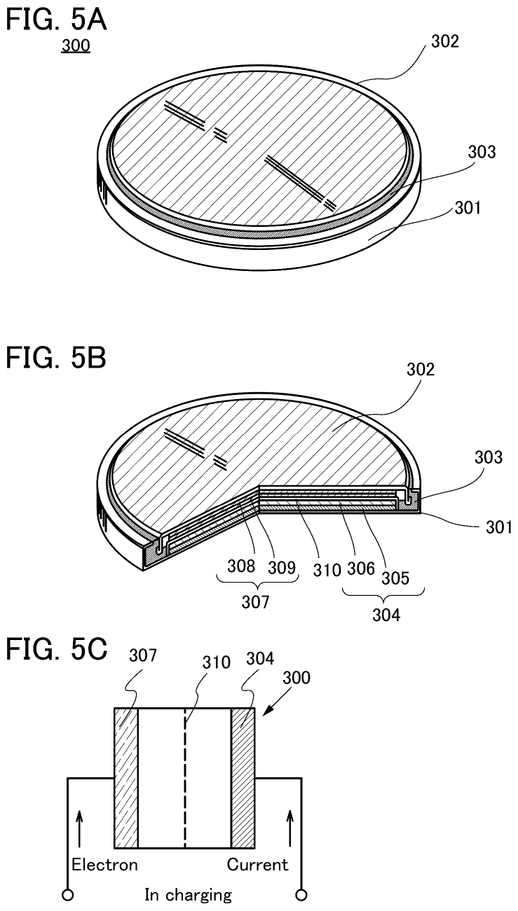

In this example, coin-type half cells are fabricated and the cycle performances thereof are compared. FIG. 5(A) is an external view of a coin-type (single-layer flat type) secondary battery, and FIG. 5(B) is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 is formed with a positive electrode current collector 305 and a positive electrode active material layer 306 provided in contact with the positive electrode current collector 305. A negative electrode 307 is formed with a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal corrosion-resistant to an electrolyte solution, such as nickel, aluminum, or titanium, an alloy of these metals, or an alloy of these metals and another metal (e.g., stainless steel) can be used. The positive electrode can 301 and the negative electrode can 302 are preferably covered with nickel, aluminum, or the like in order to prevent corrosion due to an electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in an electrolyte, and as illustrated in FIG. 5(B), the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 therebetween, whereby the CR2032-type (diameter: 20 mm, height: 3.2 mm) coin-type secondary battery 300 is fabricated.

Here, a current flow in charging the secondary battery will be described with reference to FIG. 5(C). When a secondary battery using lithium is regarded as a closed circuit, lithium ions move and a current flows in the same direction. Note that in the secondary battery using lithium, an anode and a cathode are switched according to whether charge or discharge is performed, and an oxidation reaction and a reduction reaction are switched; hence, an electrode with a high reaction potential is called a positive electrode and an electrode with a low reaction potential is called a negative electrode. For this reason, in this specification, the positive electrode is referred to as a “positive electrode” or a “+ pole (plus pole)” and the negative electrode is referred to as a “negative electrode” or a “— pole (minus pole)” in all the cases where charge is performed, discharge is performed, a reverse pulse current is supplied, and a charging current is supplied. If the terms anode and cathode relating to an oxidation reaction and a reduction reaction are used, confusion might be caused because they change places according to whether charge or discharge is performed. Thus, the terms anode and cathode are not used in this specification. If the terms anode and cathode are used, whether it is the time of charging or discharging is specified and whether it corresponds to the positive electrode (plus pole) or negative electrode (minus pole) is mentioned.

Two terminals illustrated in FIG. 5(C) are connected to a charger, and the secondary battery 300 is charged. As the charge of the secondary battery 300 proceeds, a potential difference between electrodes increases. The positive direction in FIG. 5(C) is the direction of a current that flows from a terminal outside the secondary battery 300 toward a positive electrode 304, flows from the positive electrode 304 toward the negative electrode 307 in the secondary battery 300, and flows from the negative electrode 307 toward a terminal outside the secondary battery 300. In other words, the direction in which a charging current flows is regarded as the direction of a current.

In this embodiment, when the positive electrode active material particles functioning as a positive electrode active material, which are described in the above embodiment, are used in the positive electrode 304, the coin-type secondary battery 300 with high cycle performance can be obtained. In this example, aluminum foil coated with carbon is used as a current collector, and lithium foil is used as a negative electrode. In addition, polypropylene was used as a separator, and as a component of an electrolyte solution, 1 mol/L lithium hexafluorophosphate (LiPF₆) was used and as another component of the electrolyte solution, a mixture in which ethylene carbonate (EC) and diethyl carbonate (DEC) at a volume ratio of EC:DEC=3:7 and 2 wt % vinylene carbonate (VC) were mixed was used.

A current collector coated with slurry in which the positive electrode active material described in the above embodiment, acetylene black (AB), and polyvinylidene fluoride (PVDF) were mixed at a weight ratio of LCO:AB:PVDF=95:3:2 was used. Drying was performed at 80° C., and pressing treatment was performed at a pressure of 210 kN/m.

### [Kinds of Samples]

Sample 1: 0.5 wt % GO (5 wt % LATP)
Sample 2: 0.2 wt % GO (5 wt % LATP)
Sample 3: 2 wt % LATP (0.5 wt % GO)
Sample 4: 4 wt % LATP (0.5 wt % GO)
Sample 5: 8 wt % LATP (0.5 wt % GO)
Sample 6: without GO or LATP
Sample 7: 0.5 wt % GO, without LATP
Sample 8: 0.2 wt % LATP (0.5 wt % GO)
Sample 9: 0.5 wt % LATP (0.5 wt % GO)

### [Evaluation of Cycle Performance]

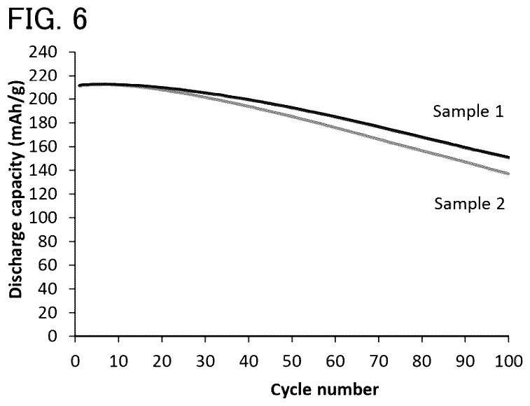

Next, the cycle performances of the above fabricated secondary batteries of Samples 1 and 2 were evaluated. FIG. 6 shows the results. According to the results in FIG. 6, Sample 1 with 0.5 wt % GO had more favorable cycle performance than the sample with 0.2 wt % GO.

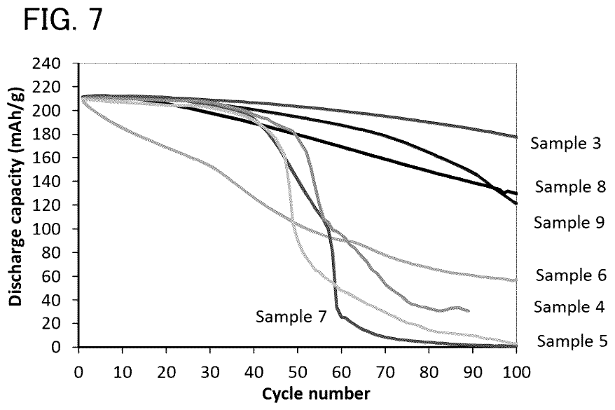

Then, the cycle performances of the secondary batteries of Samples 3, 4, 5, 7, 8, and 9 each with a GO concentration fixed to 0.5 wt % were evaluated. Samples 5 and 6 are comparative examples. As for the cycle performances, charge was performed at CC/CV, 1.0 C, 4.55 V, and cut off at 0.05 C, and discharge was performed at CC, 1.0 C, and cut off at 3.0 V. The measurement temperature of the cycle performances was 45° C. and the measurement was performed for 100 cycles. FIG. 7 shows the results. According to the results in FIG. 7, Sample 3 with 2 wt % LATP had higher cycle performance than the other samples. In Sample 3, the initial discharge capacity was approximately 210 mAh/g, and was approximately 177 mAh/g even after 100 cycles; the discharge capacity retention rate of was 83.8%.

### [Charging and Discharging Methods]

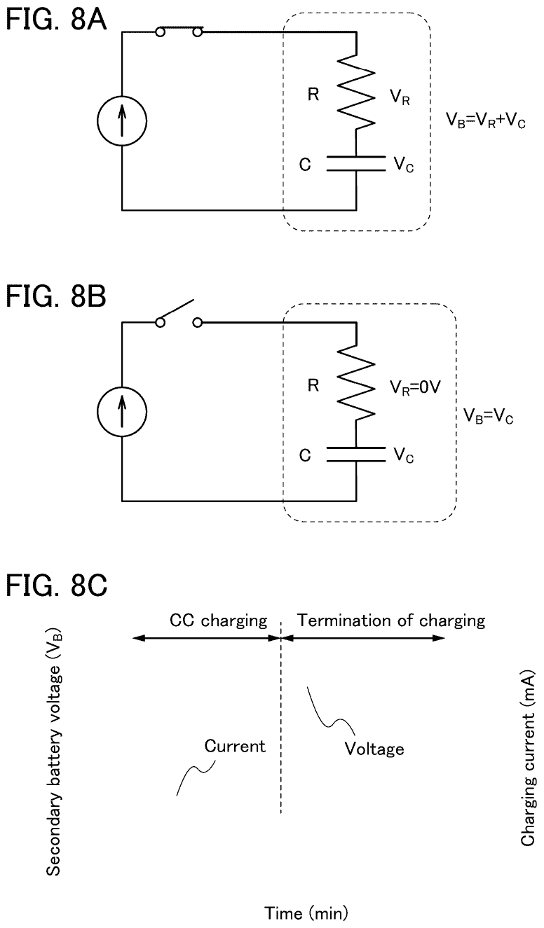

The secondary battery can be charged and discharged in the following manner, for example.

<<CC charging>> First, CC charging, which is one of charging methods, will be described. CC charging is a charging method in which a constant current is made to flow to a secondary battery in the whole charging period and charging is terminated when the voltage reaches a predetermined voltage. The secondary battery is assumed to be an equivalent circuit with internal resistance R and secondary battery capacitance C as illustrated in FIG. 8(A). In that case, a secondary battery voltage V_{B} is the sum of a voltage V_{R} applied to the internal resistance R and a voltage V_{C} applied to the secondary battery capacitance C.

While the CC charging is performed, a switch is on as illustrated in FIG. 8(A), so that a constant current I flows to the secondary battery. During the period, the current I is constant; thus, according to the Ohm's law of V_{R}=R×I, the voltage V_{R} applied to the internal resistance R is also constant. By contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, the charging is terminated. On termination of the CC charging, the switch is turned off as illustrated in FIG. 8(B), and the current I becomes 0. Thus, the voltage V_{R} applied to the internal resistance R becomes 0 V. Consequently, the secondary battery voltage V_{B} is decreased by the lost voltage drop in the internal resistance R.

FIG. 8(C) shows an example of the secondary battery voltage V_{B} and charging current during a period in which the CC charging is performed and after the CC charging is terminated. The state is shown in which the secondary battery voltage V_{B} increases while the CC charging is performed, and slightly decreases after the CC charging is terminated.

<<CCCV charging>> Next, CCCV charging, which is a charging method different from the above-described method, will be described. CCCV charging is a charging method in which CC charging is performed until the voltage reaches a predetermined voltage and then CV (constant voltage) charging is performed until the amount of current flow becomes small, specifically, a termination current value.

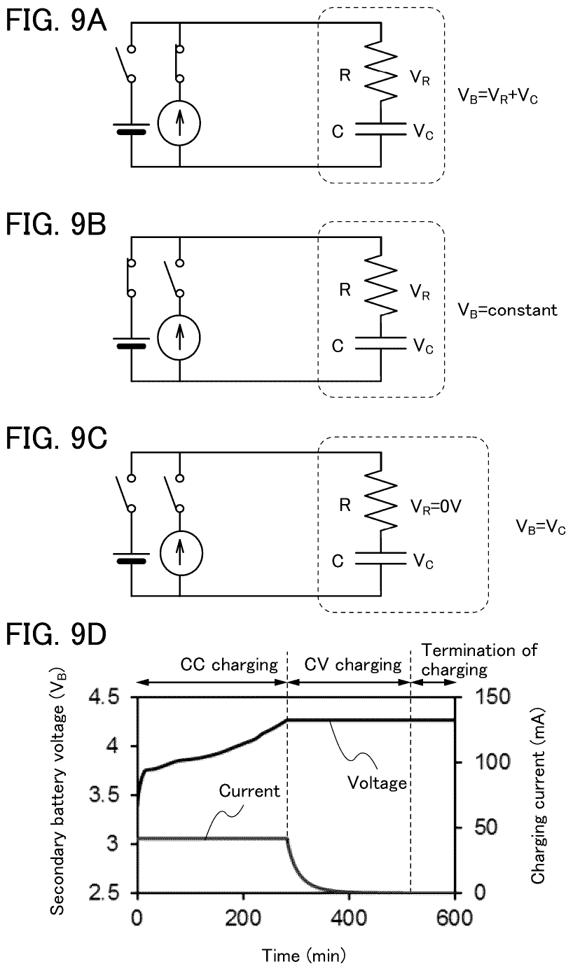

While the CC charging is performed, a switch of a constant current power source is on and a switch of a constant voltage power source is off as illustrated in FIG. 9(A), so that the constant current I flows to the secondary battery. During the period, the current I is constant; thus, according to the Ohm's law of V_{R}=R×I, the voltage V_{R} applied to the internal resistance R is also constant. By contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, switching is performed from the CC charging to the CV charging. While the CV charging is performed, the switch of the constant voltage power source is on and the switch of the constant current power source is off as illustrated in FIG. 9(B); thus, the secondary battery voltage V_{B} is constant. By contrast, the voltage V_{C} applied to the secondary battery capacitance C increases over time. Since V_{B}=V_{R} V_{C} is satisfied, the voltage V_{R} applied to the internal resistance R decreases over time. As the voltage V_{R} applied to the internal resistance R decreases, the current I flowing to the secondary battery also decreases according to the Ohm's law of V_{R}=R×I.

When the current I flowing to the secondary battery becomes a predetermined current, e.g., approximately 0.01 C, the charging is terminated. On termination of the CCCV charging, all the switches are turned off as illustrated in FIG. 9(C), so that the current I becomes 0. Thus, the voltage V_{R} applied to the internal resistance R becomes 0 V. However, the voltage V_{R} applied to the internal resistance R becomes sufficiently small due to the CV charging; thus, even when a voltage drop no longer occurs in the internal resistance R, the secondary battery voltage V_{B} hardly decreases.

FIG. 9(D) shows an example of the secondary battery voltage V_{B} and charging current while the CCCV charging is performed and after the CCCV charging is terminated. The state is shown in which even after the CCCV charging is terminated, the secondary battery voltage V_{B} hardly decreases.

### <<CC Discharging>>

Next, CC discharging, which is one of discharging methods, will be described. CC discharging is a discharging method in which a constant current is made to flow from the secondary battery in the whole discharging period, and discharging is terminated when the secondary battery voltage V_{B} reaches a predetermined voltage, e.g., 2.5 V.

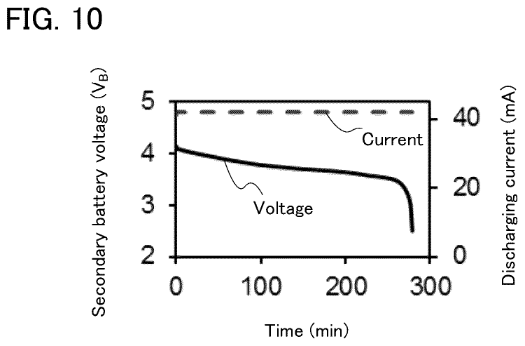

FIG. 10 shows an example of the secondary battery voltage V_{B} and discharging current while the CC discharging is performed. The state is shown in which as discharging proceeds, the secondary battery voltage V_{B} decreases.

Next, a discharge rate and a charge rate will be described. The discharge rate refers to the relative ratio of discharging current to battery capacity and is expressed in a unit C. A current of approximately 1 C in a battery with a rated capacity X (Ah) is X (A). The case where discharge is performed at a current of 2 X (A) is rephrased as follows: discharge is performed at 2 C. The case where discharge is performed at a current of X/5 (A) is rephrased as follows: discharge is performed at 0.2 C. Similarly, the case where charge is performed at a current of 2 X (A) is rephrased as follows: charge is performed at 2 C. The case where charge is performed at a current of X/5 (A) is rephrased as follows: charge is performed at 0.2 C.

### REFERENCE NUMERALS

280: spray-drying apparatus, 281: chamber, 282: nozzle, 283: tube, 284: suspension, 285: heater, 286: collection container, 287: collection container, 288: arrow, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 8021: charging apparatus, 8022: cable, 8024: secondary battery, 8400: automobile, 8401: headlight, 8406: electric motor, 8500: automobile, 8600: motor scooter, 8601: side mirror, 8602: secondary battery, 8603: indicator, 8604: storage unit under seat, 8700: electric bicycle, 8701: secondary battery, 8702: battery pack, 8703: display portion.

This application is based on Japanese Patent Application Serial No. 2017-092039 filed with Japan Patent Office on May 3, 2017, the entire contents of which are hereby incorporated herein by reference.

1. A method for manufacturing positive electrode active material particles, comprising:
spraying a suspension containing lithium compound particles containing lithium, a transition metal element, and oxygen, a graphene compound, a solid electrolyte, and a solvent; and
performing heating to transform carbon contained in a surface into carbon dioxide and to volatilize the carbon.

2. The method for manufacturing positive electrode active material particles, according to claim 1, wherein a spray nozzle is used for the spraying.

3. The method for manufacturing positive electrode active material particles, according to claim 1, wherein the solid electrolyte is a NASICON phosphate compound.

4. The method for manufacturing positive electrode active material particles, according to claim 1, wherein the solvent is water and ethanol.

5. The method for manufacturing positive electrode active material particles, according to claim 1, wherein the heating is performed at a temperature higher than or equal to a melting point of the solid electrolyte in an air atmosphere.

6. The method for manufacturing positive electrode active material particles, according to claim 1, wherein the transition metal element is cobalt.

7. A method for manufacturing a positive electrode active material particle, comprising:
forming a suspension by mixing lithium cobalt oxide containing magnesium and fluorine, graphene oxide, a phosphate compound containing lithium, aluminum, and titanium, and a solvent; and,
spraying the suspension to obtain powder; and
heating the powder,
wherein the heating is performed at a temperature higher than or equal to a temperature that the phosphate compound is synthesized.

8. The method for manufacturing a positive electrode active material particle according to claim 7, wherein the temperature is greater than or equal to 800° C.

9. The method for manufacturing a positive electrode active material particle according to claim 8, wherein the temperature is 900° C.

10. The method for manufacturing a positive electrode active material particle according to claim 7, wherein a spray nozzle is used for the spraying.

11. The method for manufacturing a positive electrode active material particle according to claim 7, wherein the solvent is water and ethanol.

12. The method for manufacturing a positive electrode active material particle according to claim 7, wherein an amount of the phosphate compound is greater than 0.2 wt % and less than 8 wt %.

13. The method for manufacturing a positive electrode active material particle according to claim 12, wherein the amount of the phosphate compound is greater than or equal to 1 wt % and less than or equal to 3 wt %.

14. The method for manufacturing a positive electrode active material particle according to claim 7, wherein a concentration of the graphene oxide is greater than or equal to 0.2 wt %.

15. The method for manufacturing a positive electrode active material particle according to claim 14, wherein the concentration of the graphene oxide is less than or equal to 0.6 wt %.
